(19) United States
(12) Patent Application Publication
(10) Pub. No.: US 2009/0144537 A1
(43) Pub. Date: Jun. 4, 2009

(54) INFORMATION PROCESSING APPARATUS AND METHOD FOR STARTING UP INFORMATION PROCESSING APPARATUS

(75) Inventor: Toshikazu Morisawa, Tokorozawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/247,890

(22) Filed: Oct. 8, 2008

(30) Foreign Application Priority Data
Nov. 30, 2007 (JP) 2007-311311

(51) Int. Cl. G06F 9/00

(52) U.S. Cl. 713/2

(57) ABSTRACT

An information processing apparatus includes: a power button; a switching unit that switches a plurality of peripheral devices connected to the apparatus between a detectable state and an undetectable state; a determination unit that determines whether the start-up operation is a normal start-up operation for starting up all of the peripheral devices or a specific start-up operation for starting up a specific peripheral device that is selected from among the peripheral devices; a first switching control unit that controls the switching unit to switch the specific peripheral device to the detectable state and to switch a non-specific peripheral device that is selected from among the peripheral devices except the specific peripheral device to the undetectable state; and a second switching control unit that controls the switching unit to switch the non-specific peripheral device to the detectable state after the specific peripheral device is detected by the operating system.

### CROSS-REFERENCE TO RELATED APPLICATIONS

This application is based upon and claims the benefit of priority from Japanese Patent Application No. 2007-311311, filed on Nov. 30, 2007, the entire content of which are incorporated herein by reference.

### BACKGROUND

1. Field

One embodiment of the present invention relates to an information processing apparatus such as a personal computer and a method for starting up the information processing apparatus.

2. Description of the Related Art

Conventionally, an information processing apparatus, such as a personal computer, is employed in various kinds of uses, for example, a preparation of a document, a calculation of a chart, a browsing of a website and is widely spread for a personal use or for a business use.

In the recent information processing apparatuses, there is such an information processing apparatus in which a reproducing device or a recording device for reading data from a recording medium or writing data in the recording medium is incorporated or externally provided, and an image or an audio is reproduced or recorded by use of such devices. Further, there is an information processing apparatus in which a TV tuner is incorporated and a program of broadcasting received by the TV tuner can be viewed and listened to.

In the conventional information processing apparatus, when a plurality of peripheral devices such as the reproducing device, the recording device, the TV tuner or the like are incorporated or externally provided, even if any of the peripheral devices is used, a driver is similarly loaded and an initializing process is performed. Therefore, in the conventional information processing apparatus, for example, only when the program of a TV broadcasting is viewed and listened to, the same time as a time necessary when the peripheral device except the TV tuner is used is required until the information processing apparatus can operate after a power is turned on. Thus, a user is required to wait for the information processing apparatus to complete the power-on process (boot process). In the description, a time period necessary for the information processing apparatus to operate after the power is turned on is referred to as a start-up time.

There is proposed an information processing apparatus in which a normal boot code procedure is performed when the apparatus is started with a first button and a simplified boot code procedure is performed when the apparatus is started with a second button to shorten the start-up time. An example of such apparatus is disclosed in JP-A-2006-092511 (counterpart U.S. publication is: US 2006/064571 A1).

According to the conventional information processing apparatus disclosed in JP-A-2006-092511, the start-up time can be shortened by starting up the information processing apparatus by the use of the second button.

However, in the above-described conventional information processing apparatus, an effect of shortening the start-up time can be anticipated when only a predetermined peripheral device is used. However, when other peripheral device than the predetermined peripheral device is used or when the predetermined peripheral device and other peripheral device are used, the effect of shortening the start-up time cannot be anticipated since the normal boot code procedure needs to be performed.

### SUMMARY

According to a first aspect of the present invention, there is provided an information processing apparatus including: a power button that is operated to input a start-up operation for turning on a power of the apparatus; a switching unit that switches a plurality of peripheral devices connected to the apparatus between a detectable state, in which the respective peripheral devices are detectable by an operating system, and an undetectable state, in which the respective peripheral devices are undetectable by the operating system; a determination unit that determines whether the start-up operation input through the power button is (A) a normal start-up operation for starting up all of the peripheral devices or (B) a specific start-up operation for starting up a specific peripheral device that is selected from among the peripheral devices; a first switching control unit that controls the switching unit to switch the specific peripheral device to the detectable state and to switch a non-specific peripheral device that is selected from among the peripheral devices except the specific peripheral device to the undetectable state; and a second switching control unit that controls the switching unit to switch the non-specific peripheral device to the detectable state after the specific peripheral device is detected by the operating system.

According to a second aspect of the present invention, there is provided a method for starting up an information processing apparatus having a power button that is operated to input a start-up operation for turning on a power of the apparatus, the method including: determining whether the start-up operation input through the power button is (A) a normal start-up operation for starting up all of peripheral devices connected to the apparatus or (B) a specific start-up operation for starting up a specific peripheral device that is selected from among the peripheral devices; switching the specific peripheral device to a detectable state to be detectable by an operating system, and to switch a non-specific peripheral device that is selected from among the peripheral devices except the specific peripheral device to an undetectable state to be undetectable by the operating system; and switching the non-specific peripheral device to the detectable state after the specific peripheral device is detected by the operating system.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate an embodiment of the invention and not to limit the scope of the invention.

FIG. 1 is a perspective view showing an external appearance of a computer according to an embodiment of the present invention.

FIG. 2 is a block diagram showing an inner configuration of the computer shown in FIG. 1.

FIG. 3 is a functional block diagram showing a configuration related to a start control process of the computer according to the embodiment of the present invention.

FIG. 4 is a flowchart showing a procedure of operations of the start control process in the computer according to the embodiment of the present invention.

FIG. 5 is a diagram showing one example of a device table.

FIG. 6 is a flowchart showing a procedure of operations of another start control process.

FIG. 7 is a diagram showing one example of an I/O port address.

### DETAILED DESCRIPTION

An embodiment of the present invention will be described below. The same components are designated by the same reference numerals and a duplicated explanation will be omitted.

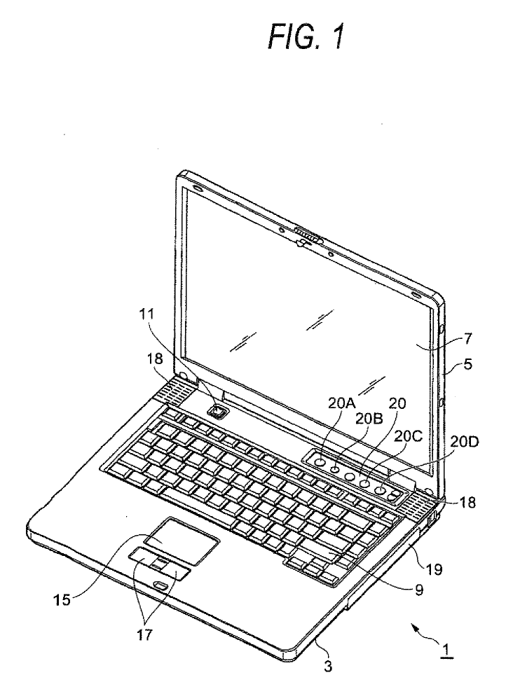

A notebook type personal computer (refer it to as a “computer” hereinafter) 1 shown in FIG. 1 includes a computer main body 3 and a display unit 5 capable of being freely opened and closed to the computer main body 3.

In the display unit 5, a TFT-LCD (Thin Film Transistor Liquid Crystal Display) 7 is incorporated. A display screen of the LCD 7 is located substantially at a central part of the display unitS. The LCD 7 is used as a display monitor of the computer 1 to display moving images, static images, characters, figures or the like.

The display unit 5 is attached so as to be freely rotated between an opened position and a closed position relative to the computer main body 3. The computer main body 3 has a thin box shaped casing and a keyboard 9, a power button 11, a touch pad 15, a click button 17, a speaker 18 and a start-up operation panel 20 are arranged on the upper face of the casing of the computer main body.

The keyboard 9 is an input operating unit that has a plurality of input keys and performs an input operation for operating the input keys by fingers to input data to a below-described embedded controller/keyboard controller IC (EC/KBC) 121 by the input operation.

The keyboard 9 includes input keys for performing an editing operation or a prescribed input operation such as an ENTER key, a Back key, a space key, an Insert key or a Delete key as well as input keys marked by English characters, kana characters and numeric characters to input the characters corresponding to the symbols marked thereon.

The power button 11 is a button to input a start-up operation by pressing down the button to power on the computer 1 and to power off the computer 1. The power button 11 is for inputting a normal start-up operation for a normal start-up. The normal start-up is a start mode for starting up all of four peripheral devices (in this embodiment, a below-described HDD 117, an HD DVD drive 119, a sound controller 113 and a digital TV tuner 125) at the same time. In the case of the normal start-up, all of below-described four switch devices 151 to 154 are closed and all the four peripheral devices are switched to a detectable state.

Further, in the start-up operation panel 20, four power buttons 20A, 20B, 20C and 20D are provided. The power buttons 20A, 20B, 20C and 20D are buttons to respectively input start-up operations to power on the computer 1. The respective power buttons 20A, 20B, 20C and 20D are for inputting specific start-up operations for starting specific start-ups. In the embodiment, each of the specific start-ups is a start mode when only a specific peripheral device of the four peripheral devices is activated in advance, the specific peripheral device corresponding to the specific start-up operation input by pressing one of the power buttons 20A-20D. In the case of the specific start-up operation, only the switch device, of the four switch devices 151 to 154, which corresponds to the pressed start-up button is switched to detectable state.

The relationship between the power buttons 20A, 20B, 20C and 20D and the switch devices 151 to 154 is stored in a below-described device table 50. In the device table 50, the power button 20A designates a button for previously starting up only the below-described HDD 117 and the power button 20B designates a button for previously starting up only the below-described HD DVD drive 119. Further, the power button 20C designates a button for starting up only the below-described digital TV tuner 125 in advance, and the power button 20D designates a button for starting up only the sound controller 113 in advance.

The computer 1 is capable of reproducing audio/video (AV) contents (of an HD DVD Video standard) stored in a DVD medium of the HD DVD standard. On a side face of the computer main body 3, a slot 19 is provided for receiving the DVD medium.

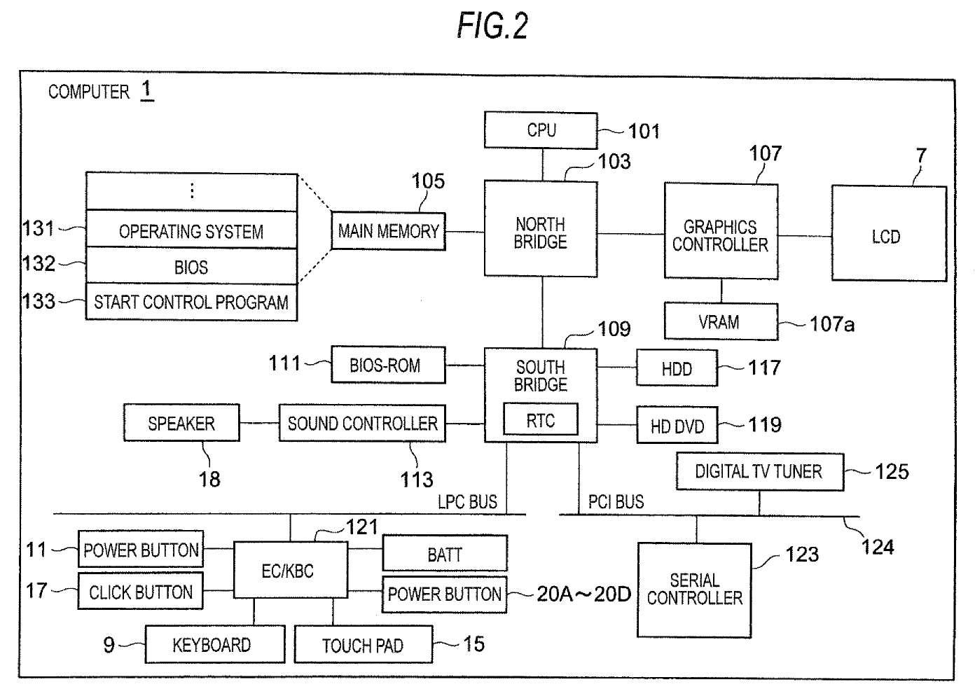

Now, referring to FIG. 2, an inner configuration of the computer 1 will be described below. As shown in FIG. 2, the computer 1 includes a CPU 101, a north bridge 103, a main memory 105, a graphics controller 107, a video memory (VRAM) 107a, a south bridge 109 and a BIOS-ROM 111.

The computer 1 further includes the sound controller 113, the hard disk drive (HDD) 117, the HD DVD drive 119, the embedded controller/keyboard controller IC (EC/KBC) 121, a serial controller 123 and the digital TV tuner.

The CPU 101 is a processor for controlling the operation of the computer 1 and executes a program loaded in the main memory 105 from the HDD 117 or the BIOS-ROM 111. The program executed by the CPU 101 includes an application program such as an HD DVD player application program, a TV application program as well as a control program such as an operating system (OS) 131, a BIOS (Basic Input Output System) 132, a start control program 133 or the like.

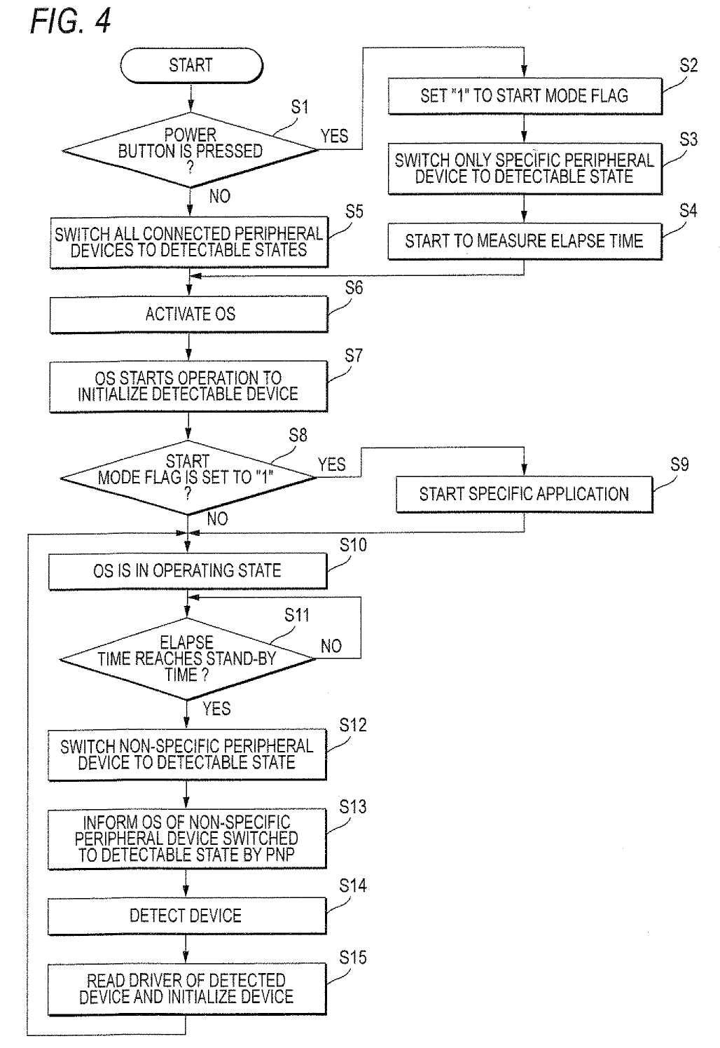

When the CPU 101 executes an operation prescribed in the OS 131 or the BIOS 132, functions as various kinds of units (a determination unit, a first switching control unit, a second switching control unit, an informing unit, a specific application activating unit) are performed. The OS 131 is stored in the HDD 117 and the BIOS 132 is stored in the BIOS-ROM 111. As described below in detail, in the BIOS 132, modules are included for performing S1 to S5 shown in FIG. 4.

The HD DVD player application program designates a program for reproducing the AV contents of the HD DVD Video standard. The TV application designates a program that allows the user to view and listen to a digital TV broadcasting.

The north bridge 103 is a bridge device for connecting a local bus of the CPU 101 to the south bridge 109. In the north bridge 103, a memory controller is also incorporated for accessing and controlling the main memory 105. Further, the north bridge 103 has a function for performing a communication with the graphics controller 107 through a serial bus of a PCI EXPRESS standard.

The main memory 105 is loaded with the operating system 131, the BIOS 132 and the start control program 133.

The graphics controller 107 is a display controller for controlling the LCD 7. The graphics controller 107 has image processing functions such as a blending process, a scaling process and a roomer key process. A display signal generated by the graphics controller 107 is sent to the LCD 7. Further, the display signal can be transmitted to an external TV or an HDMI monitor through an interface provided in the computer main body 3.

The south bridge 109 controls devices respectively on a PCI (Peripheral Component Interconnect) bus 124 or devices respectively on an LPC (low Pin Count) bus. Further, the south bridge 109 incorporates therein an IDE (Integrated Drive Electronics) controller for controlling the HDD 117 and the HD DVD drive 119.

The south bridge 109 also has a function for performing a communication with the sound controller 113. The sound controller 113 is a sound source device and outputs audio data as an object to be reproduced to the speaker 18.

In the HDD 117, video data or audio data is stored together with the operating system 131 and the BIOS 132. Further, in the HDD 117, the device table 50 is stored.

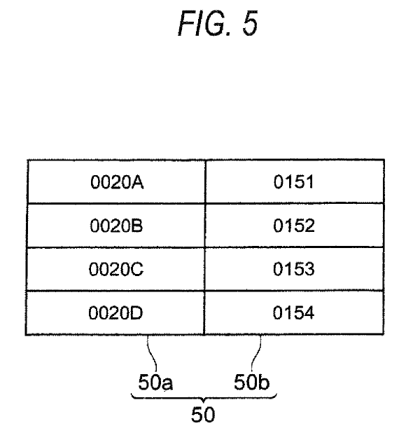

The device table 50 includes, as shown in FIG. 5, a button code storing section 50a that stores button codes for identifying the plurality of power buttons 20A, 20B, 20C and 20D and a switch code storing section 50b that stores switch codes for identifying the switch devices to store the button codes and the switch codes coordinated with each other. The switch device corresponding to the pressed down power button can be specified by the device table 50.

The embedded controller/keyboard controller IC (EC/KBC) 121 is a one chip microcomputer in which an embedded controller and a keyboard controller are integrated. The embedded controller controls an electric power.

The EC/KBC 121 has a function for turning on/off a power of the computer 1 in accordance with a pressing down operation of the power button 11. Further, the EC/KBC 121 has a function for turning on the power of the computer 1 in accordance with the pressing down operation of the power buttons is 20A, 20B 20C and 20D.

The serial controller 123 is a control unit for controlling a data transfer by a serial transfer system.

The computer 1 is provided with the digital TV tuner 125 so as to view and listen to a digital TV broadcasting. The CPU 101 executes the above-described TV application so that a TV video based on a digital broadcast wave received by the digital TV tuner 125 is displayed on the LCD 7.

The digital TV tuner 125 is a receiving unit for receiving a program of a digital broadcasting such as a ground digital broadcast and connected to an antenna terminal not shown in the drawing.

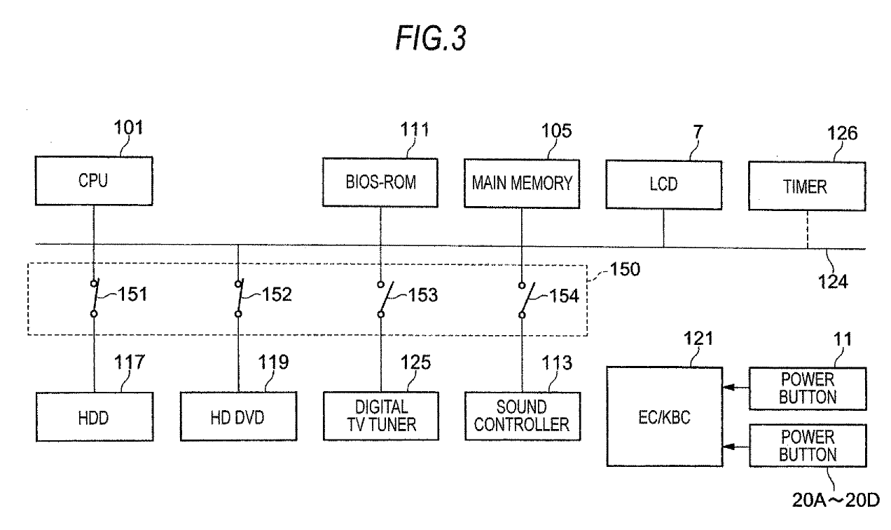

FIG. 3 is a functional block diagram showing a configuration of the computer 1 related to a start control process. As shown in FIG. 3, the computer 1 includes, as the configuration related to the start control process, the CPU 101, the main memory 105, the BIOS-ROM 111, the LCD 7, the power button 11 and the power buttons 20A to 20D. Further, the computer 1 includes a group of switches 150 and a timer 126 as well as the EC/KBC 121 and the plurality of peripheral devices (the HDD 117, the HD DVD driver 119, the digital TV tuner 125 and the sound controller 113.

The group of switches 150 includes the switch devices 151, 152, 153 and 154. The switch devices 151 to 154 respectively have functions as switching units for individually performing mechanical opening and closing operations in accordance with an instruction of the CPU 101 to switch a corresponding peripheral device to a detectable state or an undetectable state. Here, the detectable state means a state that the OS 131 can detect the peripheral device and the undetectable state means a state that the OS 131 cannot detect the peripheral device.

The switch devices 151 to 154 are formed with, for example, switches and respectively connect the HDD 117, the HD DVD drive 119, the digital TV tuner 125 and the sound controller 113 to the PCI bus 124 or disconnect them from the PCI bus 124.

The timer 126 serves as a measuring unit for measuring an elapsed time in accordance with the instruction of the computer 1. The elapsed time begins to be measured when a below-described non-specific peripheral device is switched to the non-detectable state.

Now, contents of operations of the start control process in the computer 1 having the above-described configuration will be described by referring to FIG. 4. In the following description, a case is assumed that when the power is turned on, the power button 11 or the power button 20C is pressed down. When the power button 11 is pressed down, the normal start-up is performed. When the power button 20C is pressed down, the specific start-up is performed.

In the computer 1, when it is detected that the power is turned on by data from the EC/KBC 121, the CPU 101 executes the start control process in accordance with a flowchart shown in FIG. 4.

When the CPU 101 starts the start control process, the CPU 101 advances an operation to S1 to perform an operation as the determination unit. The CPU 101 determines whether or not the power button (any of 20A to 20D) is pressed down on the basis of data showing a factor of the start obtained from the EC/KBC 121. When the power button is pressed down, since the start-up operation is the specific start-up operation corresponding to the specific start-up, the CPU 101 advances an operation to S2. When the power button is not pressed down, the CPU 101 advances the operation to S5.

When the CPU 101 advances the operation to S2, the CPU 101 sets data showing the specific start-up to a start mode flag (in this embodiment, “1” is set. However, other data may be set). Further, in subsequent S3, to set only the specific peripheral device to the detectable state, the CPU 101 refers to the device table 50 to determine the switch device corresponding to the pressed down power button.

The CPU 101 performs an operation as the first switching control unit to switch only the determined switch device to a closed state and switch other switch devices to opened states. The CPU 101 advances an operation to S4 and instructs the timer 126 to begin to measure the elapsed time.

On the other hand, when the CPU 101 advances the operation to S5, the CPU 101 switches all the switch devices 151, 152, 153 and 154 to the closed states in order to make the switch devices detectable. The above-described operations of S1 to S5 are realized by operating the CPU 101 in accordance with the BIOS.

Then, the CPU 101 advances an operation to S6 to activate the OS 131. Subsequently, the CPU 101 advances an operation to S7 to start an operation under the control of the OS 131, detect a detectable peripheral device and read and initialize the driver of the detected peripheral device.

Subsequently, the CPU 101 advances an operation to S8 to perform an operation as the determination unit and determines whether or not “1” is set to the above-described start mode flag. When “1” is set to the start mode flag, the CPU 101 advances an operation to S9. However, when “1” is not set to the start mode flag, the CPU 101 does not execute S9 and advances an operation to S10.

When the CPU 101 advances the operation to S9, the CPU 101 performs an operation as a specific application start control unit to start an application (in this embodiment, the TV application corresponding to the digital TV tuner 125) corresponding to the peripheral device that can be detected.

Then, when the CPU 101 advances the operation to S10, the CPU 101 maintains an operating state of the OS 131. Then, the CPU 101 advances an operation to S11 to wait until the elapsed time measured by the timer 126 passes a stand-by time. When the elapsed time passes the stand-by time, the CPU 101 advances an operation to S12. Here, the stand-by time indicates a time during which the OS 131 is allowed to wait for detecting a non-specific peripheral device. The stand-by time may be a prescribed time or varied. The non-specific peripheral device is other device than the specific peripheral device of the peripheral devices. In this embodiment, the HDD 117, the HO DVD drive 119 and the sound controller 113 are assumed.

Then, when the CPU 101 advances the operation to S12, the CPU 101 performs an operation as the second switching control unit to switch the switch device in the opened state to the closed state from the opened state. When the CPU 101 switches the switch device to the closed state, the non-specific peripheral device is switched to the detectable state.

In subsequent S13, the CPU 101 performs an operation as the informing unit to inform the OS 131 of the non-specific peripheral device switched to the detectable state in S12 by a PnP (plug and play) function.

The CPU 101 advances an operation to S14 to perform an operation for detecting the device. In next S15, the CPU 101 reads the driver of the detected peripheral device to initialize the peripheral device. Then, the CPU 101 returns to S10 to repeat the above-described operations.

In the device table 5, the switch device 153 is coordinated with the power button 20C. In this embodiment, since a case is assumed that the power button 20C is pressed down as the specific start-up, the digital TV tuner 125 designates the specific peripheral device and other peripheral devices than the digital TV tuner 125 designate the non-specific peripheral devices.

Accordingly, in the above-described S3, only the switch device 153 is switched to the closed state and other switch devices 151, 152 and 154 are switched to the opened state.

Then, in the above-described S9, the TV application is started. Further, in the above-described S12, the switch devices 151, 152 and 154 are switched to the closed states. In next S13, the HDD 117, the HD DVD drive 119 and the sound controller 113 are reported to the OS 131 by the PnP and detected in S14.

As described above, in the computer 1, when the power is activated, if the power buttons 20A to 20D are pressed down, the start-up operation indicates the specific start-up operation. Then, only the specific peripheral device (in this embodiment, the digital TV tuner 125) of the plurality of peripheral devices corresponding to the specific start-up operation by the pressed down start button is switched to the detectable state and other non-specific peripheral devices are switched to the detectable states after the OS 131 detects the specific peripheral device.

Therefore, in the computer 1, when the specific start-up that the power buttons 20A to 20D are pressed down is performed, only the specific peripheral device corresponding to the pushed power button is initialized in advance. At that time, non-specific peripheral devices other than the specific peripheral device are not initialized. Further, when the power button separate from the power button 20C is pressed down, only the peripheral device corresponding to the pressed down power button is previously activated as the specific peripheral device. Accordingly, when the computer 1 uses any of the peripheral devices, a processing time required for an initialization is shortened so that an effect of shortening a start-up time can be obtained.

Further, the non-specific peripheral device is switched to the detectable state so as to be detected by the OS 131, and the initialization corresponding to non-specific peripheral device is performed afterward. Therefore, even when the computer 1 activates not only the specific peripheral device, but also other peripheral devices than the specific peripheral device, the effect of shortening the start-up time of the specific peripheral device can be obtained.

When the specific start-up is performed that the power buttons 20A to 20D are pressed down, the computer 1 allows the OS 131 to detect only the peripheral device of the plurality of peripheral devices required for the present and initializes the required peripheral device. The computer 1 allows the OS 131 to detect afterward other peripheral devices than the required peripheral device and initializes other peripheral devices. Therefore, since the necessary peripheral device is early initialized, the effect of shortening the start-up time of the specific peripheral device can be obtained.

Further, when the non-specific peripheral device is switched to the detectable state, the computer 1 informs the OS 131 that the non-specific peripheral device is in the detectable state (S13). Accordingly, the non-specific peripheral device is switched to the detectable state afterward as if the non-specific peripheral device were added. However, also in the case of the specific start-up, since under a state that the OS 131 is activated, the operation can be continuously performed as in the case of the normal start-up, so that the OS 131 may not be reactivated to detect the non-specific peripheral device.

Further, after only the specific peripheral device is switched to the detectable state, the specific device is detected, and then, when the elapsed time passes the stand-by time, the non-specific peripheral device is switched to the detectable state (S11, S12). Accordingly, the specific peripheral device and the non-specific device are assuredly detected before and after in view of time by the OS 131.

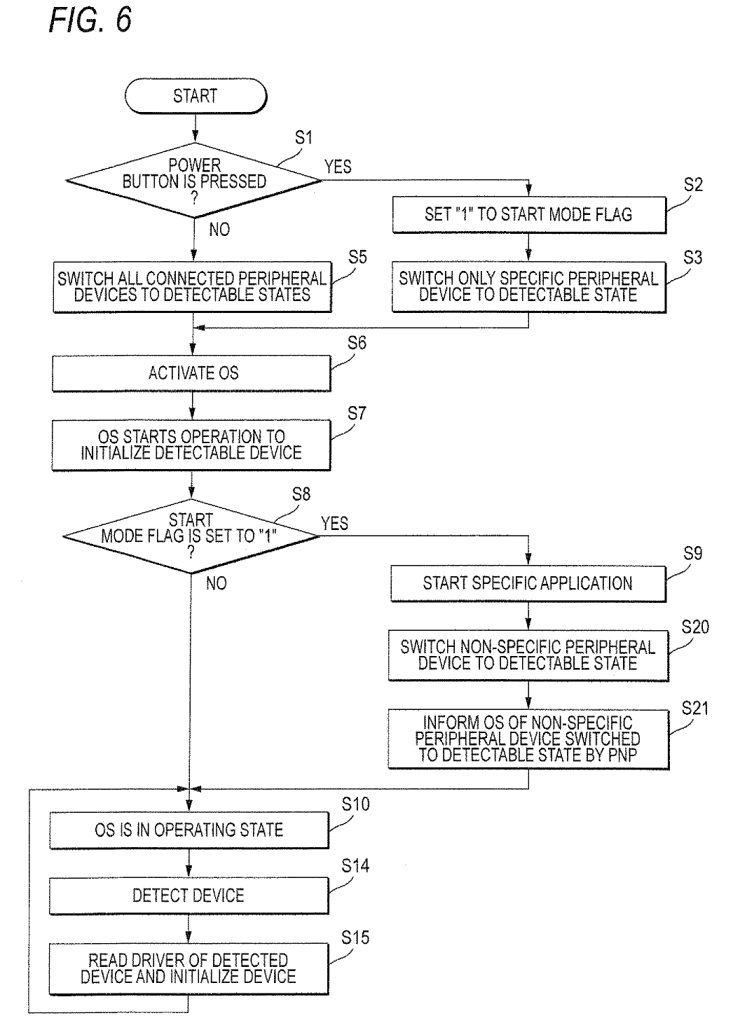

The CPU 101 can also execute the start control process in accordance with a flowchart shown in FIG. 6. The flowchart shown in FIG. 6 is different from the flowchart shown in FIG. 4 from the viewpoints that S4 is not performed after S3, and after S9 is performed and before S10 is performed, S20 and S21 are performed. The different points of the flowchart shown in FIG. 6 from the flowchart shown in FIG. 4 will be mainly described below.

Then, after the CPU 101 executes S9, the CPU 101 advances an operation to S20 to switch the switch device in the opened state to the closed state from the opened state in the same manner as that of the above-described S12. Further, in next S21, the CPU 101 operates as the informing unit in the same manner as that of the above-described S13 to inform the OS 131 of the non-specific peripheral device switched to the detectable state in S20 by a PnP (plug and play) function. After that, the CPU 101 advances an operation to S10 to perform the same process as that of the flowchart shown in FIG. 4.

Also in this case, the non-specific peripheral device is switched to the detectable state after the OS 131 detects the specific peripheral device. Accordingly, in the computer 1, when the specific start-up is performed, only the specific peripheral device is initialized in advance. At that time, non-specific peripheral devices other than the specific peripheral device are not initialized. Accordingly, a processing time required for an initialization is shortened so that an effect of shortening a start-up time can be obtained.

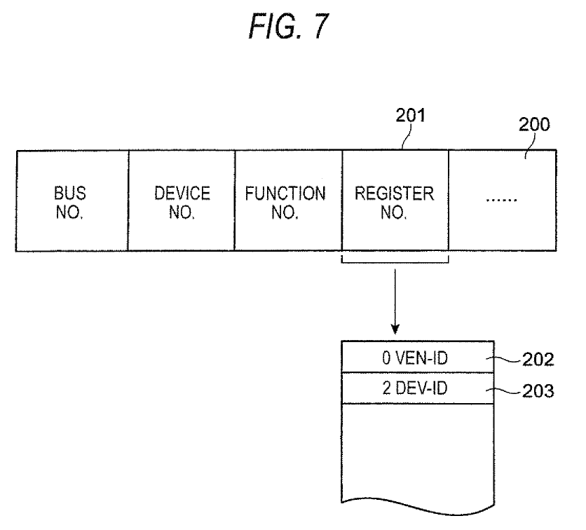

In the above-described embodiment, as an example, the switch devices 151 to 154 are respectively described as the switches that perform the mechanical opening and closing operations. However, the switch devices may be respectively realized by units for rewriting Vender ID 202 and Device ID 203 defined in a register NO 201 of an I/O port address 200 shown in FIG. 7. In this case, when the Vender ID 202 is set to “OXEFFF” and the Device ID 203 is set to “OXFFFF”, the peripheral device is brought into an undetectable state. Accordingly, in S3, only for the switch device corresponding to the specific peripheral device, the Vender ID 202 and the Device ID 203 can be set to “OXFFFF”.

The above-described description is directed to the embodiment of the present invention and does not restrict the device and the method of the present invention. Various modified examples may be easily realized. Further, a device or a method formed by suitably combining together the components, the functions and the features or the steps of the method in each of the embodiments may be included in the present invention.

As the computer 1, for example, a portable notebook type personal computer is assumed in this embodiment, however, the present invention is not limited to the notebook type personal computer. Further, in this embodiment, an example that the computer 1 incorporates therein the plurality of peripheral devices is described, however, the present embodiment may be applied to a case that at least any one of the peripheral devices is externally attached.

As described above in detail, according to the present invention, there is provided an information processing apparatus and a method for starting up the information processing apparatus, in which an effect of shortening a start-up time is obtained not only when a determined peripheral device is used, but also when a plurality of peripheral devices are provided and any of the plurality of peripheral devices is used.

What is claimed is:

1. An information processing apparatus comprising:
a power button that is operated to input a start-up operation for turning on a power of the apparatus;
a switching unit that switches a plurality of peripheral devices connected to the apparatus between a detectable state, in which the respective peripheral devices are detectable by an operating system, and an undetectable state, in which the respective peripheral devices are undetectable by the operating system;
a determination unit that determines whether the start-up operation input through the power button is (A) a normal start-up operation for starting up all of the peripheral devices or (B) a specific start-up operation for starting up a specific peripheral device that is selected from among the peripheral devices;
a first switching control unit that controls the switching unit to switch the specific peripheral device to the detectable state and to switch a non-specific peripheral device that is selected from among the peripheral devices except the specific peripheral device to the undetectable state; and
a second switching control unit that controls the switching unit to switch the non-specific peripheral device to the detectable state after the specific peripheral device is detected by the operating system.

2. The apparatus according to claim 1 further comprising an informing unit that informs the operating system that the non-specific peripheral device is switched to the detectable state when the non-specific peripheral device is switched to the detectable state.

3. The apparatus according to claim 1 further comprising a measuring unit that measures an elapsed time after the switching unit switches the non-specific peripheral device to the undetectable state,
wherein the second switching control unit controls the switching unit to switch the non-specific peripheral device to the detectable state when the elapsed time measured by the measuring unit elapses a stand-by time during which the operating system is set to stand-by detecting the non-specific peripheral device.

4. The apparatus according to claim 1 further comprising a specific application activating unit that activates a specific application that requires the specific peripheral device after the specific peripheral device is switched to the detectable state;
wherein the second switching control unit controls the switching unit to switch the non-specific peripheral device to the detectable state after the specific application is activated by the specific application activating unit.

5. The apparatus according to claim 1, wherein the power button includes a normal power button that is operated to input the normal start-up operation and a specific power button that is operated to input the specific start-up operation.

6. The apparatus according to claim 1, wherein the switching unit has a plurality of switches for respectively switching the peripheral devices between the detectable state and the undetectable state, and
wherein the first switching control unit controls the switching unit to turn on a specific switch that corresponds to the specific peripheral device and included in the switches to switch the specific peripheral device to the detectable state and to turn off a non-specific switch that corresponds to the non-specific peripheral device and included in the switches to switch the non-specific peripheral device to the undetectable state.

7. The apparatus according to claim 5, wherein the switching unit has a plurality of switches for respectively switching the peripheral devices between the detectable state and the undetectable state,
wherein the first switching control unit controls the switching unit to turn on a specific switch that corresponds to the specific peripheral device and included in the switches to switch the specific peripheral device to the detectable state and to turn off a non-specific switch that corresponds to the non-specific peripheral device and included in the switches to switch the non-specific peripheral device to the undetectable state,
wherein the power button includes a plurality of specific power buttons that are operated to input the specific start-up operation for the respective peripheral devices, and
wherein the apparatus further comprises a device code storing unit that stores identifying codes of the respective specific power buttons and identifying codes of the respective switches being correlated with one another.

8. The apparatus according to claim 1, wherein the first switching control unit controls the switching unit to switch all of the peripheral devices to the detectable state when the determination unit determines whether the start-up operation is the normal start-up operation.

9. The apparatus according to claim 2, wherein the informing unit informs the operating system that the non-specific peripheral device is switched to the detectable state through a plug-and-play function.

10. The apparatus according to claim 1, wherein the determination unit and the first switching control unit are incorporated in a BIOS that controls the peripheral devices.

11. A method for starting up an information processing apparatus having a power button that is operated to input a start-up operation for turning on a power of the apparatus, the method comprising:
determining whether the start-up operation input through the power button is (A) a normal start-up operation for starting up all of peripheral devices connected to the apparatus or (B) a specific start-up operation for starting up a specific peripheral device that is selected from among the peripheral devices;
switching the specific peripheral device to a detectable state to be detectable by an operating system, and to switch a non-specific peripheral device that is selected from among the peripheral devices except the specific peripheral device to an undetectable state to be undetectable by the operating system; and
switching the non-specific peripheral device to the detectable state after the specific peripheral device is detected by the operating system.
